(19) United States
(12) Patent Application Publication
(10) Pub. No.: US 2008/0140541 A1
(43) Pub. Date: Jun. 12, 2008

(54) Method and System for Reselling of Assets Through Communication Network

(76) Inventors: Samuel Weisman, Ramat-Gan (IL); Yacov Korman, Reshon Le-Zion (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/609,366

(22) Filed: Dec. 12, 2006

(51) Int. Cl. G06Q 30/00

(52) U.S. Cl. 705/27

(57) ABSTRACT

The present invention is a method for supporting resale of assets and properties, such as cars, real-estate properties etc, via a single website, that enables easy access, viewing and updating of assets related information. Furthermore, the present invention enables access to formal asset-related institutes, prophesized in related areas, for the purpose of retrieving and representing asset-related information such as: expert value estimations, mechanical examinations of resale assets etc, whereas representation of information is exhibited in a single website.

### FIELD OF THE INVENTION

The present invention generally relates to the field of sales. More specifically, the present invention is a system and a method for reselling of assets via network applications.

### BACKGROUND OF THE RELATED ART

Buying and selling resale assets, such as cars, motorcycles, real estate properties, etc. is a complicated process that involves a great deal of searching for assets for resale and searching for assets related information, as well as a great deal of evaluating and testing of the said assets for resale.

Many internet websites enable the search of assets related information, such as various web-bulletin boards for used cars, web-bulletin boards for real-estate properties, etc.

Websites that enable access to resale asset information usually give out very brief and basic information regarding the assets themselves. Most of the information provided regards contact details of the seller and very few details regarding the asset itself. As an example, web-bulletin boards for used cars usually give out the model of the car, year of manufacture, color, catalog price, number of previous owners, etc, and the contact details of the seller. As another example, web-bulletin boards for resale of properties usually give out the number of rooms, the property size, the location details of the property, the contact details of the seller, etc.

Said websites that enable access to resale asset information such as bulletin boards usually do not give out professional and authorized information such as the asset condition estimated and evaluated by an expert.

The main problem that occurs when seeking information regarding resale assets is that most of the substantial and critical information regarding the assets, such as the asset physical condition, is not accessible in those websites. As an example, when seeking information regarding used cars, buyers usually wish to know the technical condition of the car. Such information may not be accessible through internet applications, since the car must be tested in a licensed, designated garage. This process of testing a potential car to buy is both time and money consuming, although also a necessary process for making wise consumer decisions.

### SUMMARY OF SOME EMBODIMENTS OF THE INVENTION

The present invention is a system and a method that enable access to tests and evaluation results of assets via network applications, wherein authorized institutes and experts carry out said tests and evaluation. The present invention further enables electronic transmission of said tests and evaluation results via network applications to a single website or any other computerized application that enables storage, representation and management of electronic information.

According to some embodiments of the invention, a seller of an asset may insert asset related information to the website via a registration website application, wherein all seller information may be stored at the said website.

According to some embodiments of the present invention, the website may enable access to other sources of information, wherein said sources may electronically transmit asset related information to said website.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of a system for resale of assets via a communication network, according to some embodiments of the invention.

FIG. 2 is a schematic illustration of a method for resale of assets via a communication network, according to some embodiments of the invention.

The drawings together with the description make apparent to those skilled in the art how the invention may be embodied in practice.

No attempt is made to show structural details of the invention in more detail than is necessary for a fundamental understanding of the invention.

### DESCRIPTION OF SOME EMBODIMENTS OF THE INVENTION

The present invention is a method and a system for supporting resale of assets via communication data network, wherein said assets value and condition arc tested and evaluated by experts, wherein the testing results (TR) 13 are electronically transmitted via a communication network.

According to some embodiments of the present invention, the system and method for supporting resale of assets may be applied by an internet website 12.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment

While the above description contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

According to some embodiments of the invention, the website 12 may be used as a supporting tool for the whole buying and selling process.

According to some embodiments of the present invention, the website 12 may enable access, storage and representation of information and visual representation relating to assets for resale that are registered in website 12.

According to some embodiments of the invention, the website 12 may allow visual representation of assets.

According to some embodiments of the invention, the website 12 may enable registration of an asset for resale through the website 12, wherein said registration includes inserting of a seller's 11 information of the said asset to the website 12 via a website 12 application.

According to some embodiments of the invention, website 12 representation of the seller's 11 information may be permitted if the seller 11 has put the asset for resale through a test that evaluates the asset value and the asset physical condition, wherein expert and authorized institutes and proffesionals have carried out the said test.

According to some embodiments of the invention, the test results TR 13 may be electronically retrieved by the website 12. The website 12 may then enable an online representation of the seller's 11 information.

The users of the website 12 are individuals that surf the website 12. The users shall be referred to hereinafter as “potential buyers” 15.

According to some embodiments of the invention, the website 12 may facilitate easy searches by enabling the potential buyers 15 to search according to key words or site-categories.

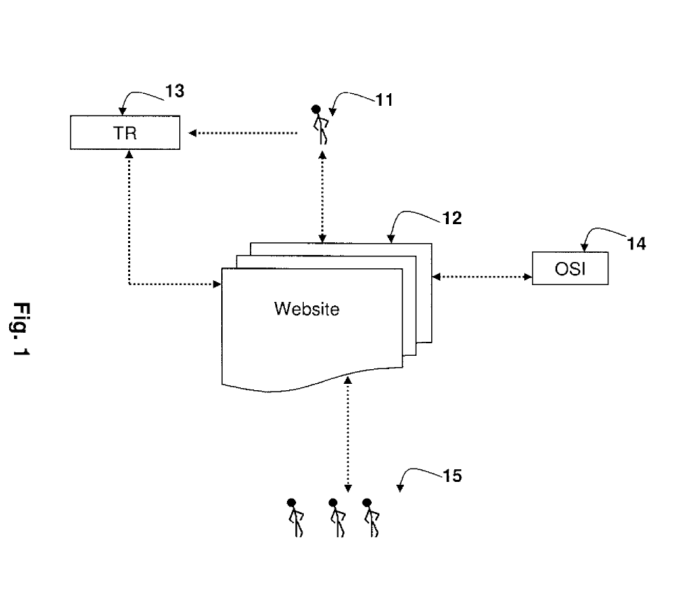

Reference is now made to FIG. 1, which schematically illustrates a system for resale of assets via a communication network, according to some embodiments of the invention, wherein said system includes:

Graphical User Interface (GUI) module for registration of an asset for resale by seller 11, wherein the seller 11 registers the asset for resale via a website 12, wherein said asset is tested and evaluated by authorized and expert institutes and professionals, wherein the test results (TR) 13 are sent to website 12.

An update module for website 12 retrieving of asset related information from external electronic sources, wherein said information may be test results (TR) retrieved from expert institutes 13, and additional asset related information retrieved from other sources of information (OSI) 14.

A report module at website 12 for processing of the retrieved TR 13, wherein said processing of TR 13 includes storage, manipulation, and representation of said TR 13.

Representation module for providing the potential buyers 15 with electronic interface for viewing all assets related information.

According to some embodiments of the invention, potential buyers 15 may be obliged to pay via website 12 applications in order to view TR 13 of assets.

According to some embodiments of the invention, the website 12 may be a bulletin board for used cars, wherein TR 13 may be the results of a technical test of a car for resale, wherein said technical test is carried out in a licensed designated garage. OSI 14 of a bulletin board for used cars may be, for example, insurance companies that may electronically transmit history of accidents reports to all cars for resale that are registered in the website 12.

According to some embodiments of the invention, the website 12 may be a bulletin board for the resale of real estate properties, wherein TR 13 may be appraisers' evaluations of the real estate properties for resale that are registered in the website 12. OSI 14 of a bulletin board for real estate properties may be, for example, municipal and execution offices that electronically update the website 12 regarding registered properties legal conditions.

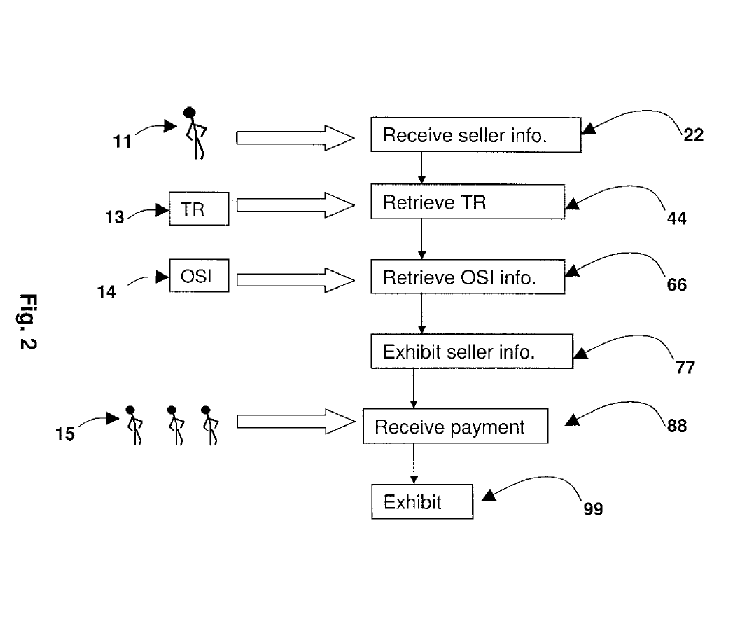

Reference is now made to FIG. 2, which schematically illustrates a method for resale of assets via a communication network, according to some embodiments of the invention wherein said method comprises the following steps:
As schematically indicated by box 22, the method includes the step of receiving asset information at Website 12 from a seller 11, wherein said information is electronically stored via website 12 applications.
As schematically indicated by box 44, the method includes the step of retrieving asset TR 13 from an authorized source, wherein said TR 13 are electronically stored via website 12 applications.
As schematically indicated by box 66, the method includes the step of retrieving asset related information from OSI 14, wherein said information is electronically stored via website 12 applications.
As schematically indicated by box 77, the method includes the step of exhibiting all seller's 11 assets information and assets related information from OSI 14 at website 12, wherein exhibition of seller's 11 and OSI 14 information is available online for all registered assets in website 12.
As schematically indicated by box 88, the method includes the step of receiving payment from a potential buyer 15 via website 12 applications.
As schematically indicated by box 99, the method includes the step of exhibiting TR 13 of all assets chosen and paid for by a potential buyer 15.

According to some embodiments of the invention, the cost for the testing and TR 13 of the assets that are registered in the website 12 is of a third party, wherein said third party is not the seller 11 and not the potential buyers 15.

According to some embodiments of the present invention, when an asset that is registered through website 12 is sold, the seller 11 and the buyer 15 of the said asset may publish the selling price of the asset via the website 12.

According to further embodiments of the present invention, it is suggested to generate a price list of assets via a website 12 application. Such a price list may be based on the statistics of published prices of registered assets that were sold, and the analysis of all related information, such as the TR 13 and information retrieved from OSI 14.

What is claimed is:

1. A method for supporting resale of assets, by providing online information related to said assets through communication data network, wherein said assets value and condition are evaluated by experts testing, wherein said method comprises the following steps:
receiving asset related information from the a seller;
retrieving asset related information from external sources;
testing of the said asset by a professional expert;
enabling a user to retrieve said information from the network;
wherein all assets available for resale are tested before their information is retrieved by said network and the users pay for retrieving said information, wherein the cost for providing said information on the network is of a third party.

2. The method of claim 1 wherein said assets are purposed to be sold and bought by one or more potential buyers, sellers and users, whereas information relating said assets is exhibited, updated and traded via said network applications.

3. The method of claim 1 wherein, receiving asset related information from a seller includes online network applications by which the seller inserts asset and seller related information.

4. The method of claim 1 wherein retrieving asset related information from external sources includes retrieving, sorting, representing, and exhibiting of said information via network applications.

5. The method of claim 1 wherein testing the asset by a professional expert includes mechanical and technical testing, appraiser evaluating, experts testing, and any other tests that are carried out by authorized and certified asset related professional institutes and personas.

6. The method of claim 1 wherein enabling users to retrieve said information from the network includes searching through the network applications defined by categories.

7. The method of claim 1 wherein all assets available for resale are tested before their information is retrieved by a network includes automatic sending of tests and evaluations results to said network applications.

8. The method of claim 1 wherein the cost for providing said information on the network is of a third party wherein the said third party is not the seller and not the user.

9. The method of claim 1 wherein the cost for providing said information on the network is of a third party includes payments for the costs of the said testing and evaluation of the said asset.

10. The method of claim 1 further comprising the step of enabling the said user to purchase a chosen asset via online communication network;

11. The method of claim 1 further comprising the steps of:
retrieving and storing information regarding prices of assets that were registered in said network and were purchased;
representation of said information regarding said prices via said network.

12. The method of claim 11 further comprising the step of generating a price list based on statistical analysis of stored prices and all related information including tests and evaluations results.

13. A system for supporting resale of assets, by providing online information related to said assets through communication data network, wherein said assets value and condition are evaluated by experts testing, wherein system comprises:
Graphical User Interface (GUI) module for receiving asset related information from the a seller;
update module for retrieving asset related information from external electronic sources;
report module for processing of test results that are electronically transmitted to said communication data network;
representation module for providing the user with electronic interface for viewing all assets related information;
wherein all assets available for resale are tested before their information is downloaded to said network and the users pay for retrieving said information, wherein the cost for providing said information on the network is of a third party.

14. The system of claim 13, wherein a report module for processing of test results, wherein said test results include results of testing of assets that are available on said communication network, wherein said testing is carried out by experts.

15. The system of claim 13, wherein the report nodule for processing of test results includes electronically retrieving, storage, manipulation and representation of said test results via a communication network.
